(19) United States
(12) Patent Application Publication
(10) Pub. No.: US 2014/0043125 A1
(43) Pub. Date: Feb. 13, 2014

(54) METHOD FOR PRODUCING FULLY DENSE RARE EARTH-IRON-BASED BONDED MAGNET

(71) Applicant: Minebea Co., Ltd., Kitasaku-gun (JP)

(72) Inventors: Fumitoshi YAMASHITA, Ikoma-shi (JP); Toshinori SUZUKI, Shuuchi-gun (JP); Haruhiro KOMURA, Toyohashi-shi (JP)

(73) Assignee: Minebea Co., Ltd., Kitasaku-gun (JP)

(21) Appl. No.: 13/960,475

(22) Filed: Aug. 6, 2013

(30) Foreign Application Priority Data
Aug. 8, 2012 (JP) 2012-175946

(51) Int. Cl. H01F 41/02

(52) U.S. Cl. CPC H01F 41/0266
USPC 335/302; 419/10

(57) ABSTRACT

Provided is a method for producing a fully dense rare earth-iron-based bonded magnet, the method comprising: kneading a non-tacky thermosetting resin composition with rare earth-iron-based magnet flakes to produce a solid granular composite magnetic material; filling the granular composite magnetic material into a cavity, applying a uniaxial pressure higher than or equal to the yield stress of the thermosetting resin composition to the granular composite magnetic material so as to produce a green compact in which voids are reduced as a result of an interaction between brittle fracture of the magnet flakes and plastic deformation of the thermosetting resin composition, the rare earth-iron-based magnet flakes are piled on top of one another highly compact in the direction of the pressure axis, and the mutual positional relations of the magnet flakes are set almost regularly; and heating the green compact to cure the thermosetting resin composition constituting the green compact.

### BACKGROUND OF THE INVENTION

1. Field of the Invention

The present invention relates to a rare earth-iron-based bonded magnet that is widely used in small-sized high performance motors. More particularly, the present invention relates to a method for producing a fully dense rare earth-iron-based bonded magnet having a reduced volume fraction of residual voids, the method including a first step of kneading rare earth-iron-based magnet flakes with a thermosetting resin composition in a molten state, which is non-tacky at normal temperature and has excellent plastic deformation ability at an external force greater than or equal to the yield point, and producing a granular composite magnetic material that is solid at normal temperature; a second step of filling the granular composite magnetic material in a cavity, compressing the granular composite magnetic material at a pressure higher than or equal to the yield point of the thermosetting resin composition at normal temperature, and thus processing the granular composite magnetic material into a green compact having a particular shape through densification of the granular composite magnetic material involving plastic deformation of the thermosetting resin composition; and a third step of heating the thermosetting resin composition of the green compact to cure, and thereby producing a bonded magnet.

2. Description of the Related Art

A nanocrystalline ribbon having an average crystal grain size of 60 nm or less, which is obtained by, for example, rapid solidification of a Nd₁₂Fe₇₇Co₅B₆ (at %) molten alloy having an alloy composition that is close to the stoichiometric composition of Nd₂Fe₁₄B by a single roll method, has a hardness as high as Hv 800 to 1000 and is linearly fractured by brittle fracture. Thus, such a nanocrystalline ribbon is known as a magnetically isotropic magnet flake. In order to utilize this flake as, for example, a magnet for permanent magnet type motor, a technology of converting this flake into a bulk magnet having a particular shape by some kind of means is needed. Regarding the means for obtaining a bulk magnet having a particular shape, for example, as disclosed in Japanese Patent Application Laid-Open (JP-A) No. 62-263612, a method of producing a green compact formed from the magnet flake described above and a solid epoxy resin solely at normal temperature, and thereafter, heating and curing the epoxy resin to obtain a bonded magnet, is generally used.

Specifically, for example, an epoxy resin that is solid at normal temperature is prepared into a solution of an organic solvent (for example, a solution of a ketone such as acetone) having a solid content of about 50 wt %, and magnet flakes and the organic solvent solution of epoxy resin are subjected to wet mixing such that the proportion of the epoxy resin with respect to the magnet flakes is about 2.0 wt % to 2.5 wt %. Subsequently, the solvent is removed from the mixture, the particle size is adjusted, and thereby a granular composite magnetic material which is non-tacky at normal temperature is obtained. This is filled in a feeder cup of a mechanical or hydraulic powder compression molding machine or the like, a predetermined amount of the granular composite magnetic material is filled in a molding die cavity, and a uniaxial pressure is applied thereto usually at normal temperature. Thus, a green compact having a particular shape is produced. Furthermore, this green compact is heated, and the epoxy resin that constitutes the green compact is thermally cured. Thereby, a so-called rare earth-iron-based bonded magnet is produced.

In regard to the rare earth-iron-based bonded magnet produced as described above, that is, a rare earth-iron-based bonded magnet having a density of 6.13 Mg/m³ that is obtained by subjecting magnet flakes produced by rapidly solidifying a Nd₁₂Fe₇₇Co₅B₆ (at %) molten alloy by a single roll method, to wet mixing together with an epoxy resin composition, followed by granulation (granulation product), compressing the granules into a particular shape at normal temperature at a pressure of about 1 GPa, and then thermally curing the epoxy resin composition, it has been reported that the volume fraction of magnet flakes was 80.5 vol %, the volume fraction of the epoxy resin composition was 8.3 vol %, and the volume fraction of residual voids was 11.2 vol % [see Ken Ikuma, Koji Akioka, Tatsuya Shimoda, Ryoji Watanabe, and Hiromi Miyadera, “Higher performance extrusion molded Nd—Fe—B-based bonded magnet”, Nihon Oyo Jiki Gakkaishi (Journal of the Magnetics Society of Japan), 18 (1994), pp. 227-230].

Furthermore, a rare earth-iron-based bonded magnet was obtained by mixing0 magnet flakes having a true density of 7.59 Mg/m³ with an epoxy resin composition having a true density of 1.30 Mg/m³, which is solid at normal temperature, and compressing this mixture at a pressure of 2.45 GPa. It was reported that the density of this rare earth-iron-based bonded magnet reached 6.31 Mg/m³, but the volume fraction of residual voids was approximately 9 vol % [see Katsuhiko Ueda, Terufumi Machida, and Kazuo Asaka, “High densification of neodymium-iron-cobalt-boron alloy/epoxy magnet by two-stage powder molding”, Funtai Oyobi Funmatsu Yakin (Powders and Powder Metallurgy), 53, 3 (2006) pp. 225-230].

Granules prepared from an epoxy resin and magnet flakes as have been reported hitherto are such that during the transition to densification (compression) as described above, in the early stage, the granules (magnet flakes that constitute the granules) are dislocated without involving brittle fracture, and take a stable position. In the next stage, the granules (magnetic flakes that constitute the granules) undergo brittle fracture when subjected to a compression pressure, and while being separated apart, the granules fill in the peripheral gaps, thereby causing densification. Furthermore, at the same time, a portion of the granules rotate and are piled on top of one another in the direction of the pressure axis. Here, the mutual positional relations of the granules (magnet flakes that constitute the granules) are almost stabilized. Of course, if the compression pressure is small, the extents of brittle fracture and gap filling of the granules (magnet flakes that constitute the granules) are also small. Therefore, the density of the green compact also becomes small.

Next, in the stage in which the pressure is released, and the green compact is released from the molding die cavity, granules (magnet flakes that constitute the granules) which have certain angles in the direction of the pressure axis that is basically in the elastic range rotate so as to return to the original positions. Thereby, the green compact that has been released from the mold come to exhibit the phenomenon of elastic recovery (springback).

In the aforementioned green compact obtained by filling granules composed of an epoxy resin composition and magnet flakes that have been produced by rapid solidification of a Nd₁₂Fe₇₇Co₅B₆ (at %) molten alloy having an alloy composition close to the stoichiometric composition of Nd₂Fe₁₄B, in a molding die cavity, compressing the granules into a particular shape at normal temperature at a pressure in the range of 1 GPa to 2.45 GPa, and releasing the product from the mold, factors such as that: 1) bonding between the magnet flakes caused by plastic deformation does not occur; and 2) residual voids exist at a volume fraction of about 9 vol % to 11.2 vol %, facilitate the rotation of the granules (magnet flakes that constitute the granules) in the stage of pressure release and release from the mold, and cause an increase in the phenomenon of elastic recovery (springback).

In addition, when the green compacts that have been hitherto reported as described above are recompressed at a pressure higher than or equal to the compressive buckling pressure (2.45 GPa), the granules (magnet flakes that constitute the granules) rotate as a whole to take new positions while filling in the brittle fractures and gaps again, and are piled on top of one another while closely adhering to one another. Accordingly, the density generally increases by 0.1 Mg/m³. However, the residual voids still exist at a volume fraction of 8 vol % [see Katsuhiko Ueda, Terufumi Machida, and Kazuo Asaka, “High densification of neodymium-iron-cobalt-boron alloy/epoxy magnet by two-stage powder molding”, Funmatsu Oyobi Funmatsu Yakin (Powders and Powder Metallurgy), 53, 3 (2006) pp. 225-230].

On the other hand, in the case where combustion driven compaction is carried out at a maximum uniaxial pressure of 2.1 GPa, a rare earth-iron-based bonded magnet having a density of 6.37 Mg/m³ is obtained, but a decrease in the residual voids still does not occur [see J. Herchenroeder, D. Miller, N. K. Sheth, M. C. Foo, and K. Nagarathnam, “High performance bonded neo magnets using high density compaction”, Journal of Applied Physics, 109 (2011) 07A743].

### SUMMARY OF THE INVENTION

However, it is known that rare earth-iron-based bonded magnets that are intended by the present invention are subject to magnetic flux loss by which, when the bonded magnets are exposed to a high temperature for a long time period, even if the bonded magnets are thereafter returned to normal temperature and are remagnetized, the bonded magnets are not restored. This is generally referred to as permanent demagnetization.

It has been reported that rare earth-iron-based bonded magnets are primarily correlated to the relationship between the volume fraction of residual voids of the magnet and permanent demagnetization, irrespective of the production method such as injection molding or compression molding, and when the residual voids are reduced, the permanent demagnetization ratio is also decreased [see J. Herchenroeder, D. Miller, N. K. Sheth, M. C. Foo, and K. Nagarathnam, “High performance bonded neo magnets using high density compaction”, Journal of Applied Physics, 109 (2011) 07A743]. Furthermore, it is believed that a main causative factor of permanent demagnetization lies in that the moisture or oxygen incorporated into the pores that are present in the inner part of the rare earth-iron-based bonded magnet accelerates a change in the structure such as oxidation and corrosion of magnet flakes in the inner part of the magnet [J. Herchenroeder, D. Miller, N. K. Sheth, M. C. Foo, and K. Nagarathnam, “High performance bonded neo magnets using high density compaction”, Journal of Applied Physics, 109 (2011) 07A743]. In addition, in regard to a rare earth-iron-based bonded magnet having a volume fraction of magnet flakes of greater than 80 vol %, brittle fracture of granules (magnet flakes that constitute the granules) that occurs during the transition to densification (compression) of the magnet implies generation of newly formed surfaces of magnet flakes that are likely to be subjected to oxidation and corrosion. As such, reduction of the residual voids in the inner part of the magnet as much as possible is regarded as an effective means for suppressing permanent demagnetization of the relevant rare earth-iron-based bonded magnet.

Furthermore, in the rare earth-iron-based bonded magnets that are intended by the present invention, the magnet surfaces are generally subjected to electrodeposition coating or spray coating with an epoxy resin in order to prevent oxidation or suppress any change in the structure such as corrosion at the magnet surfaces of magnet flakes. However, the internal residual voids of a rare earth-iron-based bonded magnet are not open pores, and closed pores are in a state of being dispersed in the inner part of the magnet. Thus, it is not possible to fill in the residual voids uniformly and completely and to thereby eliminate incorporation of oxygen or moisture that is contained in the residual voids, by a certain means for impregnation through the surfaces.

On the other hand, the amount of residual voids of a rare earth-iron-based bonded magnet obtained by a conventional injection molding method is found to be about 1.5 vol % in terms of volume fraction [see Shuji Mino, Masahiro Asano, and Naoyuki Ishigaki, “Development of anisotropic Nd—Fe—B-based bonded magnet”, Sumitomo Tokushu Kinzoku Kibo, 12 (1997) pp. 43-48]. However, the volume fraction of magnet flakes of the relevant magnet obtained by an injection molding method is such that 65 vol % is considered as the threshold value, and this means that the residual magnetization Mr of the relevant bonded magnet remains no more than about 65% of magnet flakes, which means that the residual magnetization is decreased by approximately 30% as compared with the residual magnetization Mr of a rare earth-iron-based bonded magnet obtained by a compression molding method of compressing magnet flakes together with an epoxy resin. This implies that, for example, regarding the torque of small-sized motors equipped with magnets having the same dimensions and the same shape, the torque is smaller by about 30% in a motor that uses a magnet produced by an injection molding method as compared with a motor that uses a magnet produced by a compression molding method. As such, although the amount of residual voids can be decreased when an injection molding method is used, the performance as a magnet is markedly impaired; therefore, a magnet for small-sized motors cannot be realized by a simple change modification of a known production method.

The present invention was achieved under such circumstances, and is intended to provide a method for producing a bonded magnet by subjecting magnet flakes together with a thermosetting resin composition to compression molding at normal temperature using a powder compression molding machine or the like. An object of the present invention is to provide a method for producing a fully dense rare earth-iron-based bonded magnet which exhibits high performance as a magnet and also has both high dimensional accuracy and high weather resistance, by adjusting the amount of residual voids of the relevant bonded magnet to approximately 3.0 vol % or less, or to 1.5 vol % or less in terms of volume fraction, while maintaining the level of residual magnetization Mr or the maximum energy product (BH)ₘₐₓ equivalent to the level of original magnet flakes.

The inventors of the present invention conducted thorough investigations in order to achieve the object described above, and as a result, the inventors found that in regard to a rare earth-iron-based bonded magnet obtainable by a compression molding method, when a thermosetting resin composition that is solid at normal temperature, which is non-tacky at normal temperature and has a property of undergoing deformation (flowing) at an external force greater than or equal to the yield point, is used, rare earth-iron-based magnet flakes are melt kneaded with the resin composition to obtain a granular composite magnetic material, and compression molding of the granules is carried out at approximately normal temperature, the maintenance of the volume fraction of the magnetic material to approximately 80 vol % or greater and reduction of only the residual voids by an amount of approximately less than 1 vol % in terms of volume fraction can be realized. Thus, the present invention was completed.

The present invention relates to a method for producing a fully dense rare earth-iron-based bonded magnet, the method including: a first step of kneading a thermosetting resin composition that is non-tacky at normal temperature and has fluidity with a yield stress, with rare earth-iron-based magnet flakes in a molten state of the resin composition, and thereby producing a granular composite magnetic material that is solid at normal temperature; a second step of filling the granular composite magnetic material into a cavity, applying a uniaxial pressure higher than or equal to the yield stress of the thermosetting resin composition to the granular composite magnetic material at a temperature lower than or equal to the melting point of the granular composite magnetic material, and thereby producing a green compact in which voids are reduced as a result of an interaction between brittle fracture of the magnet flakes and plastic deformation (flowing) of the thermosetting resin composition, the rare earth-iron-based magnet flakes are piled on top of one another highly compact in the direction of the pressure axis, and the mutual positional relations of the magnet flakes are defined to be almost regularly; and a third step of heating the green compact, and curing the thermosetting resin composition that constitutes the green compact.

In the producing method, it is preferable that the green compact having a particular shape be a green compact in which the volume fraction of the rare earth-iron-based magnet flakes in the green compact is 78.87 vol % or more, the volume fraction of the thermosetting resin composition is 18.05 vol % or less, and the volume fraction of residual voids is 3.08 vol % or less in a condition that the sum of the volume fractions of the rare earth-iron-based magnet flakes, the thermosetting resin composition and the residual voids is 100 vol %.

Furthermore, it is preferable that the thermosetting resin composition according to the present invention contain an unsaturated polyester alkyd (A) that is solid at normal temperature, an allylic copolymerizable monomer (B), and an organic peroxide as a polymerization initiator.

Moreover, in order to obtain a granular composite magnetic material that is non-tacky at normal temperature, it is preferable that the unsaturated polyester alkyd (A) be composed of a dicarboxylic acid component and a glycol component, the dicarboxylic acid component include phthalic acid and fumaric acid at a molar ratio of phthalic acid/fumaric acid=5/5 to 1/9, the glycol component include 1,4-butanediol and another glycol at a molar ratio of 1,4-butanediol/another glycol=7/3 to 10/0, and the unsaturated polyester alkyd (A) have a melting point of 80° C. to 120° C. and an acid value of 20 or less.

Furthermore, it is preferable that the allylic copolymerizable monomer (B) be a triallyl isocyanurate, and more suitably a trifunctional allylic copolymerizable monomer having a triazine ring.

Also, it is preferable that the mixing ratio of the unsaturated polyester alkyd (A) and the allylic copolymerizable monomer (B) be B/(A+B)=5 wt % to 40 wt % as a mass ratio.

On the other hand, the rare earth-iron-based magnet flakes according to the present invention are preferably magnetically isotropic rare earth-iron-based rapidly solidified flakes containing at least one or more selected from the group consisting of an R—Fe—B-based magnet, an R—Fe(Co)—B-based magnet having a portion of Fe replaced with Co, an R—Fe—B-M-based magnet, an R—Fe—(Co)—B-M-based magnet having a portion of Fe replaced with Co, an R₂Fe₁₄B nanocrystalline structure having an alloy composition including unavoidable impurities, an R₂Fe(Co)₁₄B nanocrystalline structure having an alloy composition including unavoidable impurities and having a portion of Fe replaced with Co, a nanocomposite structure of α-Fe and R₂Fe₁₄B, and a nanocomposite structure of α-Fe and R₂Fe(Co)₁₄B having a portion of Fe replaced with Co where R represents any one rare earth element selected from yttrium (Y), cerium (Ce), praseodymium (Pr), neodymium (Nd), gadolinium (Gd), terbium (Tb), dysprosium (Dy) and holmium (Ho); and M represents one kind or a combination of two or more kinds selected from silicon (Si), aluminum (Al), niobium (Nb), zirconium (Zr), hafnium (Hf), molybdenum (Mo), gallium (Ga), phosphorus (P) and carbon (C).

Furthermore, regarding the rare earth-iron-based magnet flakes, magnetically isotropic rare earth-iron-based rapidly solidified flakes containing at least one or more selected from the group consisting of a Sm—Fe—N-based magnet, a Sm—Fe—M′—N-based magnet, a Sm₂Fe₁₇Nₓ(x≈3) nanocrystalline structure having an alloy composition including unavoidable impurities, and a nanocomposite structure of α-Fe and Sm₂Fe₁₇Nₓ(x≈3) (wherein M′ represents one kind or a combination of two or more kinds selected from hafnium (Hf), zirconium (Zr), silicon (Si), niobium (Nb), titanium (Ti), gallium (Ga), aluminum (Al), thallium (Ta), and carbon (C)), may also be well used.

Also, it is preferable that the fully dense rare earth-iron-based bonded magnet thus obtained have a residual magnetization value Mr of 0.74 T or greater and a maximum energy product (BH)ₘₐₓ of 90 kJ/m³ or greater in a measured magnetic field (external magnetic field) Hm of 2.4 MA/m.

Furthermore, when the green compact having a particular shape is a circular green compact, it is preferable that the radial crushing strength of the circular green compact be 20 MPa or greater. This level is twice or more of the strength obtainable in the related art. In regard to the third step described above, when the thermosetting resin composition that constitutes the circular green compact is heated and cured while having the outer circumferential surface of the circular green compact restrained with a support, the circular green compact can be made into an integral rigid body with a support.

Furthermore, according to another aspect of the present invention, there are provided a fully dense rare earth-iron-based bonded magnet having a volume fraction of rare earth-iron-based magnet flakes of 78.87 vol % or more, a volume fraction of a thermosetting resin composition of 18.05 vol % or less, and a volume fraction of residual voids of 3.08 vol % or less in a condition that the total of the volume fractions of the rare earth-iron-based magnetic flakes, the thermosetting resin composition and the residual voids is 100 vol %. The present invention further considers a green compact of the unfinished material having the same properties.

According to still another aspect of the present invention, there is provided a small-sized motor equipped with the fully dense rare earth-iron-based bonded magnet produced as described above.

According to the production method of the present invention, in regard to a rare earth-iron-based bonded magnet produced by a compression molding method, the volume fraction of the magnetic material can be maintained to be 78.87 vol % or more, and the volume fraction of residual voids can be adjusted to 3.08 vol % or less. That is, when the amount of the residual voids of the bonded magnet is adjusted to approximately 3.0 vol % or less, or to 1.5 vol % or less, while the levels of the residual magnetization Mr and the maximum energy product (BH)ₘₐₓ are maintained, the phenomenon of elastic recovery (springback) is suppressed, and this leads to an increase in the radial crushing strength in the case of shaping the bonded magnet into a circular shape. Thus, a fully dense rare earth-iron-based bonded magnet having high dimensional accuracy can be produced.

Moreover, a reduction in the residual voids can suppress the corrosion and structural change in the rare earth magnetic material caused by the moisture oxygen and heat that can exist in the residual voids, which are the main causative factors of permanent demagnetization, and durability (that is, weather resistance) of the magnet under a long-term exposure to a high temperature can be improved.

Furthermore, according to the present invention, since a fully dense rare earth-iron-based bonded magnet having reduced residual voids can be produced, this leads to the realization of matters such as that: 1) for example, deburring in barrel polishing or the like after magnet production, or surface treatments (coating of magnet surfaces with an epoxy resin, and the like) can be abolished; 2) since the thermosetting resin used as a binder is radical-polymerizable, a curing treatment proceeds in a short time, and since the thermosetting resin is polymerization-inert in the normal temperature range, refrigerated storage thereof is not necessary, and long-term storage of the magnetic material at normal temperature is enabled; 3) by employing an allylic unsaturated polyester resin as a binder, the bonded magnet can be produced at lower cost as compared with the conventional magnets using epoxy resin systems; 4) unlike the conventional production methods for epoxy resin systems, since mixing of the binder and magnet flakes can be carried out in a solvent-free manner, an excess solvent (subsidiary material for consumption) or solvent removal is unnecessary; and 5) recycling or reuse of an intermediate material of the fully dense rare earth-iron-based bonded magnet (granular composite magnetic material) is enabled, and the product yield can be increased. Further, it can be expected that these lead to a reduction in the production cost for the fully dense rare earth-iron-based bonded magnet.

### BRIEF DESCRIPTION OF THE DRAWINGS

FIG. 1 is a conceptual diagram illustrating the relationship between deformation (flow) and stress in a thermosetting resin composition;

FIG. 2 is a characteristics diagram illustrating the relationship between the relative density RD and pressure Pₑₓ in a green compact;

FIG. 3 is a conceptual diagram of the transition to densification (compression);

FIG. 4 is a characteristics diagram illustrating the relationship between the compression pressure and the springback in the radial direction of a cylindrical sample;

FIG. 5 is a characteristics diagram illustrating the relationship between the compression pressure and the residual voids;

FIG. 6 is a characteristics diagram illustrating the relationship between the relative density RD and the residual voids Vₐᵢᵣ;

FIG. 7 is a characteristics diagram illustrating the relationship between the relative density RD and the maximum energy product (BH)ₘₐₓ;

FIG. 8 is a characteristics diagram illustrating a demagnetization curve of a rare earth-iron-based bonded magnet; and

FIG. 9 is a characteristics diagram illustrating the relationship between the logarithmic magnetic flux loss value and the reciprocal number of standing temperature.

### DETAILED DESCRIPTION OF THE PREFERRED EMBODIMENTS

As described above, the rare earth-iron-based bonded magnets produced according to a compression molding method as having been suggested hitherto, have residual voids present at a volume fraction of approximately 9 vol % to 11 vol %, and it has been considered that in order to reduce the residual voids, it is a proper choice for those having skill in the art to employ not a compression molding method but an injection molding method or an extrusion molding method, which results in deteriorated magnetic characteristics. However, it has been pointed out that the latter molding methods require high processing temperatures, and there is a risk of the occurrence of deterioration caused by a structural change in the magnetic material during the processing process.

Here, the inventors of the present invention conducted an investigation on employing, as a binder for a magnetic material, for example, a thermosetting resin composition composed of an unsaturated polyester alkyd and an allylic copolymerizable monomer, which is non-tacky at normal temperature and has fluidity exhibiting a yield stress, instead of the conventional thermosetting resin compositions containing epoxy resins that are solid at normal temperature.

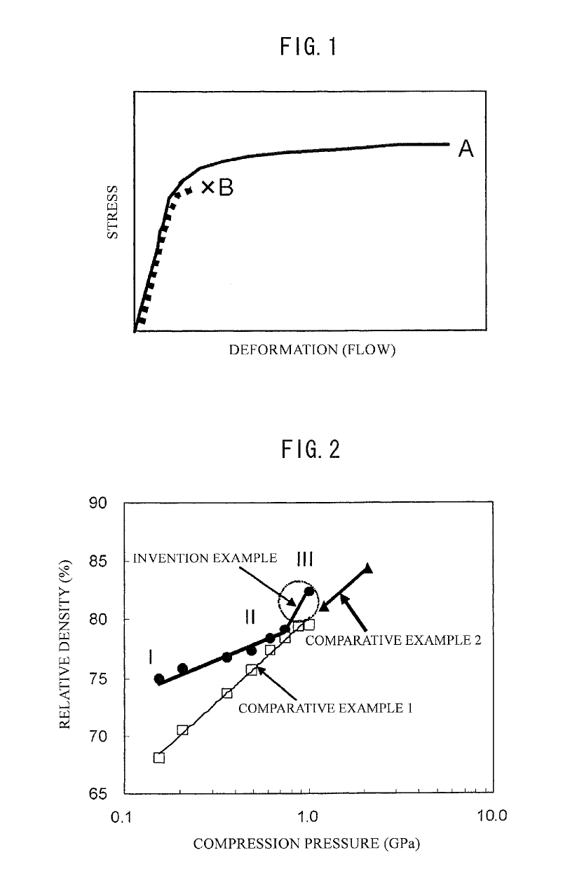

In regard to the conventional granules that use a conventional thermosetting resin composition (for example, an epoxy oligomer that is solid at normal temperature), the magnet flakes that constitute the granules undergo brittle fracture when subjected to a compression pressure, as indicated by Curve B of FIG. 1, and while being separated apart, the granules fill in the peripheral gaps, thereby causing densification. Furthermore, at the same time, a portion of the granules rotate and are thereby piled on top of one another highly compactly in the direction of the pressure axis. Here, the mutual positional relationship between the granules (magnet flakes) is almost stabilized.

On the contrary, granules of a thermosetting resin composition having a nature such as indicated by Curve A according to the present invention and magnet flakes are such that when a pressure higher than or equal to the yield stress of the thermosetting resin composition is applied, the thet mosetting resin composition undergoes plastic deformation (flowing) simultaneously with the brittle fracture of the magnet flakes at a stress greater than or equal to the yield stress of the transition to densification (compression), and through such an interaction, the thermosetting resin composition fill in the gaps in the periphery of the granules and thus reduce pores. Also, at the same time, a portion of the granules rotate and are thereby piled on top of one another highly compactly in the direction of the pressure axis. Here, the mutual positional relationship of the magnet flakes that constitute the granules is almost stabilized. As a result, the inventors of the present invention found that a green compact having very few residual voids, and a fully dense rare earth-iron-based bonded magnet having very few residual pores as described in the present invention can be produced.

As such, the present invention has a significant feature of employing a resin composition imparted with a property in which when a pressure is applied to a thermosetting resin composition that constitutes a granular composite magnetic material at a temperature lower than or equal to the melting point of the resin composition, the thermosetting resin composition exhibits Bingham flow (flow with a yield stress) such as indicated by Curve A shown in FIG. 1.

That is, in the present invention, the certain amount of a granular composite magnetic material, that is non-tacky at normal temperature and has excellent anti-blocking properties, is filled in a molding die cavity. A uniaxial pressure is then applied to the granular composite magnetic material at a temperature lower than or equal to the melting point of the thermosetting resin composition contained in the granules so as to produce a fully dense rare earth-iron-based bonded magnet. Here, in process of the pressure application, the granules are adhered to each other at an early stage of the transition to densification (compression). Plastic deformation (flowing) of the granules is then caused due to a pressure that is greater than yield stresses of the thermosetting resin composition contained in the granules. As a result of the plastic deformation (flowing) of the granules, each contact surface of the granules adjacent to each other is expanded so as to reduce gaps between the adjacent granules. The fully dense rare earth-iron-based bonded magnet is thus produced.

Hereinafter, the present invention will be described in more detail.

### [Thermosetting Resin Composition]

The thermosetting resin composition according to the present invention is a thermosetting resin composition which is solid at normal temperature, is non-tacky, and has fluidity with a yield stress.

Particularly, a preferred thermosetting resin composition according to the present invention is an allylic unsaturated polyester resin composition, and more particularly, the thermosetting resin composition is constituted to include a complete solution of an unsaturated polyester alkyd (A) and an allylic copolymerizable monomer (B), and an organic peroxide. Preferably, the thermosetting resin composition is a thermosetting resin composition constituted to include a complete solution of an unsaturated polyester alkyd (A) and an allylic copolymerizable monomer (B) having a melting point of 30° C. or lower and an organic peroxide, which composition is solid and non-tacky at normal temperature, and has a melting point of 80° C. to 120° C. and an acid value of 20 or less.

In regard to this thermosetting resin composition (complete solution), the initiation point (yield pressure) of Bingham flow (flow with a yield stress) such as indicated by Curve A shown in FIG. 1 can be easily adjusted by changing the proportion of the allylic copolymerizable monomer (B).

The unsaturated polyester alkyd (A) described above, which is solid at normal temperature, is non-tacky, and has a melting point of 80° C. to 120° C. and an acid value of 20 or less, is formed from a dicarboxylic acid component and a glycol (diol) component.

The dicarboxylic acid component is preferably composed of phthalic acid and fumaric acid, and phthalic acid or a derivative thereof and fumaric acid are used as raw materials. Meanwhile, in the following descriptions in the present specification, the expression “phthalic acid” includes the meaning of “phthalic acid or a derivative thereof”. If, for example, maleic anhydride or maleic acid is used instead of fumaric acid, a granular composite magnetic material which is non-tacky at normal temperature and has excellent anti-blocking properties cannot be obtained.

The use ratio of phthalic acid/fumaric acid is preferably 5/5 to 1/9, and particularly preferably 4/6 to 2/8 (molar ratio).

Regarding the glycol component, it is preferable to use 1,4-butanediol alone, or 1,4-butanediol and another glycol in combination. At this time, the ratio of 1,4-butanediol/other glycol is preferably 7/3 to 10/0, and particularly preferably 8/2 to 9.5/0.5 (molar ratio).

Examples of the other glycol component that is used in combination with 1,4-butanediol include ethylene glycol, propylene glycol, neopentyl glycol, diethylene glycol, dipropylene glycol, 2,2,4-trimethyl-1,3-pentanediol, 1,5-pentanediol, 1,6-hexanediol, 2,2-dimethyl-3-hydroxypropyl-2,2-dimethyl-3-hydroxypropionate, hydrogenated bisphenol A, and ethylene oxide or propylene oxide adducts of bisphenol A. Here, preferred examples of the other glycol component that can be used include propylene glycol, neopentyl glycol, and dipropylene glycol.

Here, even in the case where the molar ratio of phthalic acid/fumaric acid of the dicarboxylic acid component is in the range of 5/5 to 1/9, if the molar ratio of 1,4-butanediol/other glycol as the glycol component is smaller than 7/3 (the molar ratio of 1,4-butanediol is less than 7), a granular composite magnetic material which is non-tacky at normal temperature and has excellent anti-blocking properties may not be obtained.

Furthermore, even if the molar ratio of 1,4-butanediol/other glycol of the diol component is in the range of 7/3 to 10/0, when the molar ratio of phthalic acid/fumaric acid as the dicarboxylic acid component is greater than 5/5 (the molar ratio of phthalic acid is more than 5), or smaller than 1/9 (the molar ratio of phthalic acid is less than 1), a granular composite magnetic material which is non-tacky at normal temperature and has excellent anti-blocking properties can be obtained; however, the thermal and mechanical characteristics of the bonded magnet that is obtainable later will not be sufficient.

The melting point of the unsaturated polyester alkyd (A) according to the present invention is preferably 80° C. to 120° C. If the melting point is lower than 80° C., a granular composite magnetic material which is non-tacky at normal temperature and has excellent anti-blocking properties is not obtained, and also, even a homogenous granular composite magnetic material may not be obtained. Furthermore, if the melting point is higher than 120° C., a granular composite magnetic material which is non-tacky at normal temperature and has excellent anti-blocking properties may be obtained, but since plastic deformability (fluidity), that is, Bingham fluidity (fluidity with a yield stress), at normal temperature and a pressure of 1 GPa or less is decreased, it is not preferable.

Examples of the allylic copolymerizable monomer (B) according to the present invention include bifunctional monomers such as diallyl isophthalate, diallyl terephthalate and diallyl orthophthalate; and trifunctional monomers such as triallyl isocyanurate which is a triazine ring compound. These can be used singly, or two or more kinds can also be used in combination so that fluidity with a yield stress such as indicated by the Curve A shown in FIG. 1 can be adjusted.

Furthermore, in general, copolymerizable monomers are classified into monomers having a vinyl group (CH₂═CH—) and monomers having an allyl group (CH₂═CH—CH₂—). In the latter monomers, even if the allyl group is activated by a radical of a peroxide as a polymerization initiator, the allyl group is stabilized by its resonance structure and adopts a resonance structure (degradable chain transfer reaction ˜R.+CH₂═CH—CH₂—X→˜RH+CH₂═CH—.CH—X [symbol] .CH₂—CH═CH—X), and the chain reaction of the polymerization reaction is inhibited. Due to this resonance effect, a monomer having an allyl group is polymerization-inactive in the normal temperature range, and it becomes advantageous for the storage stability at normal temperature of the green compact (bonded magnet material before curing) that will be prepared later. Furthermore, allylic copolymerizable monomers all have high vapor pressures and do not easily volatilize. Even from this point of view, a granular composite magnetic material having excellent storage stability at normal temperature can be obtained by using the allylic copolymerizable monomer (B).

The proportions (concentrations) of the unsaturated polyester alkyd (A) and the allylic copolymerizable monomer (B) are such that B/(A+B)=5 wt % to 40 wt % as a mass ratio. For example, if the concentration of the allylic copolymerizable monomer (B) is less than 5 wt %, a granular composite magnetic material that is non-tacky is obtained; however, since the plastic deformation ability (flow) at normal temperature and a pressure of 1 GPa or less is decreased (Bingham fluidity is decreased), it is not preferable. Furthermore, if the concentration of the allylic copolymerizable monomer (B) is greater than 40 wt %, since the radial crushing strength (rigidity) of the green compact that will be prepared later is decreased, it is not preferable.

The polymerization initiator that is contained in the thermosetting resin composition according to the present invention may be, for example, an organic peroxide. Examples of the organic peroxide include methyl ethyl ketone peroxide, cyclohexane peroxide, t-butyl hydroperoxide, cumene hydroperoxide, diisopropylbenzene hydroperoxide, 2,5-dimethylhexane-2,5-dihydroperoxide, p-menthane hydroperoxide, di-t-butyl peroxide, t-butyl cumyl peroxide, dicumyl peroxide, 2,5-dimethyl-2,5-di(benzyolperoxy)hexane, t-butyl peroxylaurate, and t-butyl peroxybenzoate and the like.

Furthermore, examples of a polymerization inhibitor that is contained in the thermosetting resin composition according to the present invention include p-benzoquinone, naphthoquinone, p-toluquinone, 2,5-diphenyl-p-benzoquinone, 2,5-acetoxy-p-benzoquinone, hydroquinone, p-t-butylcatechol, 2,5-di-t-butylhydroquinone, di-t-butyl-p-cresol, and hydroquinone monomethyl ether. These polymerization inhibitors can be used as mixtures of two or more kinds and the like. Meanwhile, the use amount of the polymerization inhibitor is 0.5 parts by mass or less relative to 100 parts by mass of the total mass of the unsaturated polyester alkyd (A) and the allylic copolymerizable monomer (B).

As described above, the thermosetting resin composition according to the present invention can contain an unsaturated polyester alkyd (A), an allylic copolymerizable monomer (B), an organic peroxide, and optionally a polymerization inhibitor, a coupling agent, an oxidation inhibitor, a lubricant and the like.

### [Rare Earth-Iron-Based Magnet Flakes]

The rare earth-iron-based magnet flakes according to the present invention are preferably magnetically isotropic rare earth-iron-based rapidly solidified flakes containing an R—Fe—B-based magnet (wherein R represents a rare earth element selected from Y, Ce, Pr, Nd, Gd, Tb, Dy and Ho); an R—Fe(Co)—B-based magnet having a portion of Fe in the aforementioned magnet replaced with Co (wherein R has the same meaning as described above); an R—Fe—B-M-based magnet or R—Fe(Co)—B-M-based magnet using one kind or a combination of two or more kinds of Si, Al, Nb, Zr, Hf, Mo, Ga, P and C (wherein R has the same meaning as described above; and M represents one kind or a combination of two or more kinds of Si, Al, Nb, Zr, Hf, Mo, Ga, P and C); an R₂Fe₁₄B or R₂Fe(Co)₁₄B nanocrystalline structure having an alloy composition formed from unavoidable impurities; or a nanocomposite structure of α-Fe and R₂Fe₁₄B or R₂Fe(Co)₁₄B (wherein R has the same meaning as described above).

Alternatively, regarding the rare earth-iron-based magnet flakes according to the present invention, magnetically isotropic rare earth-iron-based rapidly solidified flakes containing an Sm—Fe—N-based magnet, an Sm—Fe-M′-N-based magnet using one kind or a combination of two or more kinds of Hf, Zr, Si, Nb, Ti, Ga, Al, Ta and C (wherein M′ represents one kind or two or more kinds of Hf, Zr, Si, Nb, Ti, Ga, Al, Ta and C), an Sm₂Fe₁₇Nₓ (x≈3) nanocrystalline structure having an alloy composition formed from unavoidable impurities, or a nanocomposite structure of α-Fe and Sm₂Fe₁₇Nₓ (x≈3), may also be well used.

Meanwhile, generally, as a magnet that is mounted in small-sized motors, magnet flakes of a nanostructure or a nanocomposite structure in which the coercive force at normal temperature is 600 kA/m or more, the saturated magnetization Ms is high, and the residual magnetization Mr exhibits an enhancement in remanence, are preferred.

[First Step: Process of Producing a Granular Composite Magnet Material that is Solid at Normal Temperature]

The first step according to the present invention is a process of bringing the thermosetting resin composition that is non-tacky at not anal temperature and has fluidity with a yield stress, to a molten state using, for example, a mixing roll; adding a predetermined amount of the rare earth-iron-based magnet flakes thereto and kneading the mixture to obtain a molten kneading product, and thus obtaining a granular composite magnet material (hereinafter, also simply referred to as “granules”) that is solid at normal temperature. Alternatively, it is also acceptable to carry out the process by mixing an unsaturated polyester alkyd (powdery), a copolymerizable monomer (liquid) and a polymerization initiator (liquid or powdery) that constitute the relevant resin composition, with rare earth-iron-based magnet flakes all together in advance; bringing the temperature of the mixture to a temperature close to the melting point of the unsaturated polyester alkyd using, for example, a mixing roll, to produce a molten unsaturated polyester resin which is a copolymerizable monomer solution of the unsaturated polyester alkyd, and simultaneously performing kneading of the molten resin and the magnet flakes.

Here, voids in the granules can be reduced by kneading the magnet flakes with the thermosetting resin composition in a molten state, and from this point of view, it is preferable to carry out the entire process of the first process without solvent, that is, in a so-called solvent-free manner.

Melt kneading is carried out by a standard method using a kneading machine that can be used for conventional thermosetting resin molding materials, such as a mixing roll, a roll mill, a co-kneader, or a twin-screw extruder.

Granulation of the melt kneading product is carried out by cooling the melt kneading product to normal temperature, crushing the cooled product, and classifying the resultant. In addition, since the melt kneading product according to the present invention has a viscoelastic property, crushing by shear compression is desirable rather than crushing by an impact force utilizing brittleness. Generally, as compared with crushing by an impact force, crushing by a shear force frequently results in a relatively small particle size and a narrow distribution width. Specifically, it is desirable to use a crushing method such as an electric stone mill having a shear compression effect in principle. At that time, the particle size of the granular composite magnetic material can be controlled by adjusting the gap between the driven board and the fixed board.

Meanwhile, the particle size range of the granular composite magnetic material according to the present invention is desirably adjusted to, for example, about 53 μm to 500 μm in consideration of fillability into a molding die cavity in the second step.

The granular composite magnetic material according to the present invention obtained as described above becomes a composite magnetic material which is non-tacky at normal temperature and is very excellent in anti-blocking properties and storage stability at normal temperature.

Furthermore, for the purpose of enhancing the powder fluidity of the classified granules, which is associated with the fillability into a molding die cavity, or reducing the friction with the molding die cavity wall surface at the time of the transition to densification (compression) of the classified granules, a general external lubricating agent such as a higher fatty acid metal soap may be dry mixed into the granules. Meanwhile, the amount of addition of the external lubricating agent is preferably 0.5 parts by mass or less relative to 100 parts by mass of the granular composite magnetic material.

### [Second Step: Process of Producing Green Compact Having Particular Shape]

Next, in the second step according to the present invention, the aforementioned granular composite magnetic material having an adjusted particle size is produced into a green compact having a particular shape by applying a uniaxial pressure thereto at a temperature lower than or equal to the melting point of the granular composite magnetic material.

The present invention has a significant feature that the granular composite magnetic material is produced into a green compact by applying a uniaxial pressure to the granular composite magnetic material at a temperature lower than or equal to the melting point of the magnetic material (for example, normal temperature (20° C.±15° C. (5° C. to 35° C.)).

The green compact thus obtainable is characterized in that the volume fraction of the rare earth-iron-based magnet flakes of in the green compact is 78.87 vol % or more, the volume fraction of the thermosetting resin composition is 18.05 vol % or less, and the volume fraction of residual voids is 3.08 vol % in a condition that the sum of the volume fractions of the rare earth-iron-based magnet flakes, the thermosetting resin composition and the residual voids is 100 vol %.

To describe the second step in more detail, first, the granular composite magnetic material is filled in a cavity, and at a temperature lower than or equal to the melting point of 100° C., a uniaxial pressure, that is, a pressure higher than or equal to the yield stress of the thermosetting resin composition, for example, a pressure of about 0.8 GPa to 1.0 GPa, is applied to the granules. Then, in the granules according to the present invention, at a pressure higher than or equal to the yield stress of the transition to densification (compression), brittle fracture of the magnet flakes that are contained in the granules occurs, and at the same time, the thermosetting resin composition undergoes plastic deformation (flow). As a result of such a synergistic effect, the gaps in the periphery of the granules are filled in. Furthermore, at the same time, a portion of the granules (magnet flakes) rotate and are thereby piled on top of one another highly compactly in the direction of the pressure axis. Here, the mutual positional relationship between the granules (magnet flakes) is almost stabilized and fixed.

Next, the pressure is released, and the green compact is released from the molding die cavity.

In this stage, the granules (magnet flakes) having a certain angle in the direction of the pressure axis that is basically in the elastic range, rotate so as to be restored to the original position. Thereby, generally, a green compact that has been released from the mold exhibits the phenomenon of elastic recovery (springback). On the other hand, in the green compact according to the present invention, after the release from the molding die cavity, the phenomenon of elastic recovery (springback) can be suppressed to a lower level than in the conventional cases.

Regarding a reason for this, it is speculated that the green compact according to the present invention, that is, a green compact that has been compressed into a particular shape at normal temperature at a pressure of about 0.8 GPa to 1.0 GPa and released from the mold, is characterized in that: 1) since the thermosetting resin composition and the magnet flakes have been kneaded in a solvent-free manner, complete embedding of the magnet flakes into the thermosetting resin composition is realized; 2) bondability of the contact surfaces between the granules is enhanced as a result of plastic deformation (flowing) of the thermosetting resin composition; and 3) the residual voids are reduced to a level of 3.08 vol % or less, for example, about 1.5 vol % to 3.0 vol %, in terms of volume fraction, so that these factors cause suppression of the rotation of the granules (magnet flakes) caused by pressure release and release from the mold, and diminution of the phenomenon of elastic recovery (springback).

Furthermore, in the case of applying the bonded magnet of the present invention to small-sized motors, a circular green compact is obtained in the present process. However, at this time, it is preferable that the circular green compact thus obtained have a radial crushing strength of 20 MPa or greater.

[Third Step: Process of Curing Thermosetting Resin Composition that Constitute Green Compact]

In the third step according to the present invention, the thermosetting resin composition that constitutes the green compact is heated and cured, and thus a fully dense rare earth-iron-based bonded magnet is obtained. The thermal curing treatment may be carried out in air.

Meanwhile, the volume change in the course of curing of a thermosetting resin composition that is solid at normal temperature goes through the following process. That is, first, due to a temperature increase caused by heating, the thermosetting resin composition thermally expands in a liquid state, and subsequently, two-dimensional crosslinking occurs. Thus, the thermosetting resin composition undergoes gelation accompanied by volumetric shrinkage. After this, the resin composition behaves as a solid and undergoes three-dimensional crosslinking, and the resin composition finally reaches the hardening point which is the end point of three-dimensional crosslinking. Thereafter, when cooled to normal temperature, the resin composition undergoes volumetric shrinkage.

By utilizing the thermal expansion in a liquid state as described above, a support and the fully dense rare earth-iron-based bonded magnet can also be formed into the shape of an integral rigid body by closely having the bonded magnet closely adhered to the support in the stage where the thermosetting resin composition in the green compact has thermally expanded in a liquid state.

For example, a circular fully dense rare earth-iron-based bonded magnet that has been integrated with a support can be produced by heating and curing the thermosetting resin composition that constitutes a circular green compact while having the outer circumferential surface of the circular green compact restrained by a support.

The fully dense rare earth-iron-based bonded magnet of the present invention and its green compact can be produced advantageously and suitably through the first step to the third step described above; however, the production method is not intended to be limited to these processes.

### EXAMPLES

Hereinafter, the present invention will be described in more detail by way of Examples. However, the present invention is not intended to be limited to these Examples.

### [Preparation of Thermosetting Resin Composition]

In a reactor equipped with a stirrer, a discharge tube, a nitrogen gas inlet tube and a thermometer, 100 mol % of 1,4-butanediol and 40 mol % of dimethyl terephthalate were introduced. As catalysts, 0.02 mol % of titanic acid tetra-n-butoxide and 0.03 mol % of antimony trioxide relative to the total amount of the acid components (dimethyl phthalate and fumaric acid that will be described below) were introduced to the reactor. The internal temperature was raised to 140° C., the temperature was further increased to 200° C. over 1.5 hours, and methanol was distilled to perform transesterification. Subsequently, the internal temperature was lowered to 160° C., and 60 mol % of fumaric acid and 150 ppm of hydroquinone (feed amount [mass] ratio with respect to fumaric acid) were introduced to the reactor. While nitrogen gas was allowed to flow at a rate of 300 mL/min, the internal temperature was raised to 155° C., the internal temperature was further increased to 160° C. over 2.0 hours, and the temperature was further increased to 210° C. over 2.5 hours. Then, the reaction was continuously carried out for 5.5 hours at the same temperature. Furthermore, during the reaction time, the nitrogen flow rate was increased to 680 mL/min for the latter 4.0 hours. After completion of the reaction, the reaction product was discharged and subjected to cooling and crystallization. Subsequently, the crystallization product was pulverized using a Henschel mixer, and thus a particulate unsaturated polyester alkyd was obtained.

With respect to the unsaturated polyester alkyd thus obtained, the use amount of the acid components and the glycol components was as follows. Acid components: phthalic acid/fumaric acid=4/6 (molar ratio), glycol components: 1,4-butanediol/other glycol=10/0 (molar ratio).

The unsaturated polyester alkyd obtained as described above had an acid value of 7.5 KOH mg/g (1 g of the unsaturated polyester alkyd was dissolved in 25 mL of chloroform, and the acid value was measured using a 1/10 Normal potassium hydroxide-ethanol solution), a melting point of 102° C., and a number average molecular weight (Mn) measured by GPC of 7,900 (measurement temperature: 40° C., and solvent: tetrahydrofuran).

Furthermore, the pulverizability with a Henschel mixer was satisfactory, and tackiness or blocking of the pulverization product was not observed.

The unsaturated polyester alkyd (A) and triallyl isocyanurate (B) having a melting point of 23° C. to 27° C. as an allylic copolymerizable monomer were blended in various combinations such that the mixing ratio would be such that B/(A+B)=5 wt % to 40 wt %, and the mixtures were melt kneaded at 90° C. to 100° C. to obtain complete solutions. 1.5 parts by mass of dicumyl peroxide as a polymerization initiator was added to 100 parts by mass of each of the complete solutions, and the resulting mixture was melt kneaded at 90° C. to 100° C. Thus, thermosetting resin compositions were prepared.

Meanwhile, dicumyl peroxide has a heat generation initiation temperature of 151° C., and a one-hour half-life temperature of 135.7° C. Therefore, when dicumyl peroxide is employed as a polymerization initiator, and the melt kneading conditions is set to about 100° C., the first step according to the present invention can be carried out at a temperature lower than or equal to the kick-off temperature, that is, under the conditions in which the curing reaction hardly proceeds.

The thermosetting resin composition prepared as described above was non-tacky at normal temperature, and had fluidity with a yield stress. That is, the thermosetting resin composition had a property of being solid at normal temperature but exhibits Bingham flow (flow with a yield stress) such as indicated by the Curve A shown in FIG. 1.

Furthermore, as described above, the magnitude of the yield stress can be easily adjusted by selecting the mixing ratio B/(A+B) of the unsaturated polyester alkyd (A) and the allylic copolymerizable monomer (B), or selecting the allylic copolymerizable monomer such as diallyl terephthalate.

Furthermore, the mixing ratio B/(A+B) of the unsaturated polyester alkyd (A) and the allylic copolymerizable monomer (B) in the present Example was set to 25 wt % as the reference, and the true density according to Archimedean method of the cured products of those thermosetting resin compositions was 1.25Mg/m³.

### [First Step (Preparation of Granular Composite Magnetic Material)]

In the present Example, as magnetic flakes of a nanocrystalline structure, magnetic flakes produced by rapidly solidifying a Nd₁₂Fe₇₇Co₅B₆ (at %) molten alloy having an alloy composition close to the stoichiometric composition of Nd₂Fe₁₄B, which had a true density of 7.59 Mg/m³, a particle size of 150 μm or less (measured according to a dry sieve method (JIS Z 8815)), a residual magnetization Mr of 0.90 T, and a coercive force HcJ of 0.8 MA/m, were used.

The magnetic flakes and the thermosetting resin composition prepared as described above were melt kneaded in a solvent-free manner, using an 8-inch mixing roll with the surface temperature set to 100° C., and thus a melt kneading product was obtained. Here, the magnet flakes and the thermosetting resin composition were mixed in various combinations such that the proportion of the thermosetting resin composition would be 2.5, 3.0, 3.5 or 4.0 wt % with respect to the melt kneading product (that is, relative to the total mass of the composite magnetic material).

Subsequently, the melt kneading product was processed to have a thickness of 1 mm or less using a constant velocity roll mill having a surface temperature of 80° C., and the resultant was subjected to crude pulverization with a Henschel mixer. Thereafter, the crude pulverization product was subjected to crushing using an electric stone mill and sieve classification, and thus a granular composite magnetic material having a particle size of 53 μm to 500 μm was obtained.

The granular composite magnetic material thus obtained had a powder fluidity of 40 seconds/50 g in the absence of an external lubricating agent. Accordingly, in the [Second step] that will be described below, the granular composite magnetic material could be filled into a molding die cavity from a feeder cup of an existing powder molding machine by a standard method. Meanwhile, a granular composite magnetic material having a particle size of 53 μm or less or a particle size of 500 μm or greater can have the product yield increased by re-crushing, or by returning the magnetic material to the process of melt kneading.

### [Second Step (Green Compact)]

3.3 g of the granular composite magnetic material obtained in the first step was filled into a molding die cavity (inner diameter: 10.08 mm), and the composite magnetic material was compressed at a temperature of 20° C. to 30° C. and a pressure of 0.15 GPa to 1.0 GPa. Thus, green compacts were obtained by applying various compression pressures.

FIG. 2 shows a characteristics diagram illustrating the relationship between the pressure Pₑₓ and the relative densities RD of green compacts produced under various compression pressures, which were obtained from granular composite magnetic materials in which a thermosetting resin composition having a mixing ratio B/(A+B) of the unsaturated polyester alkyd (A) and the allylic copolymerizable monomer (B) of 25 wt %, was incorporated in an amount of 3.5 wt % relative to the total mass of the composite magnetic material.

In addition, the relationship between pressure Pₑₓ and the respective relative densities RD of green compacts obtained under various compression pressures, which were produced under the same conditions as the second step described above using, instead of the thermosetting resin compositions described above, an epoxy resin composition-containing granular composite magnetic material (amount of incorporation of the epoxy resin relative to the total mass of the composite magnetic material: 2.5 wt %) that had been prepared by dissolving an epoxy resin that is solid at normal temperature (containing diglycidyl ether bisphenol A type epoxy oligomer: EPIKOTE 1002 and 4,4′-diphenylmethane diisocyanate regeneration product at a ratio of OH/NCO=1) in an organic solvent, wet mixing the organic solution with the magnetic flakes, subjecting the resulting mixture to solvent removal, crushing and classification, and adjusting the particle size of the composite magnetic material thus obtained (Comparative Example 1), and green compacts obtained by impact compressing the epoxy resin composition-containing magnetic materials described above (Comparative Example 2), is also shown in FIG. 2 together.

Here, the true density according to Archimedean method of a sample obtained by thermally curing only a resin composition based on an epoxy resin, was 1.16 Mg/m³. Furthermore, in the present specification, the relative density RD means the value obtained by dividing the density of a green compact by the true density of the magnetic flakes (7.59 Mg/m³).

In Comparative Example 1, that is, in the transition to densification (compression) of an epoxy resin and magnet flakes corresponding to the conventional magnetic material, in the early stage, the granules (magnet flakes) undergo dislocation without involving brittle fracture, and take stable positions. In the next stage, the granules (magnet flakes) undergo brittle fracture under a compression pressure, and while being separated apart, the granules fill in the peripheral gaps, thereby causing densification. Furthermore, at the same time, a portion of the granules rotate and are piled on top of one another in the direction of the pressure axis. Here, the mutual positional relations of the granules (magnet flakes that constitute the granules) are almost stabilized. Of course, if the compression pressure is small, the extents of brittle fracture and gap filling of the granules (magnet flakes that constitute the granules) are also small. Therefore, the density of the green compact also becomes small.

The relationship between the relative density RD and the compression pressure Pₑₓ in the green compact of Comparative Example 1 shown in FIG. 2 was such that a logarithmic approximation formula: RD=6.2534Ln(Pₑₓ)+80.106 was established with a correlation coefficient of 0.9951. However, the relative densities RD at a compression pressure of 0.87. GPa and 1.00 GPa were 79.43% and 79.56%, respectively, and the green compact showed a tendency of saturation.

Furthermore, the relative densities RD of the green compacts obtainable by impact compression as shown in Comparative Example 2 of FIG. 2 were positioned at the level such that the logarithmic approximation formula of Comparative Example 1 was extrapolated.

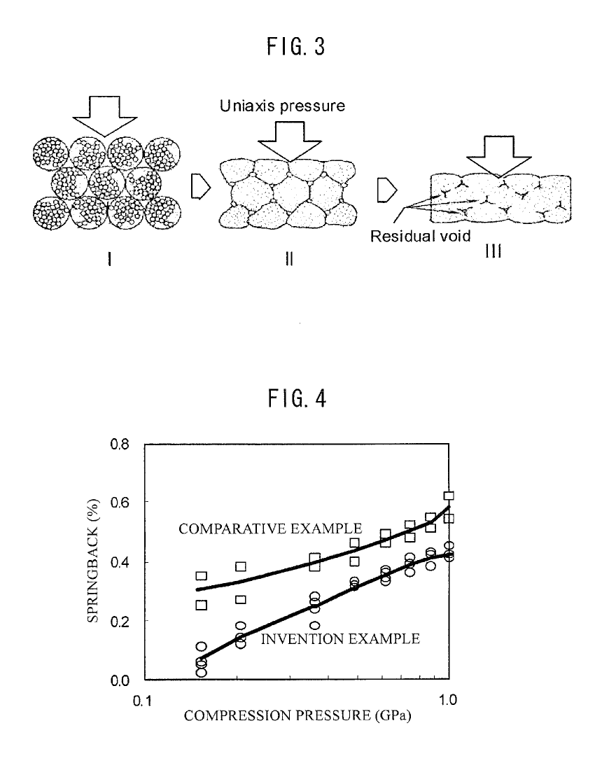

FIG. 3 is a conceptual diagram of the transition to densification (compression) according to the present invention shown in FIG. 2. Meanwhile, diagrams I, II and III of FIG. 3 correspond to the sections I, II and III of the Invention Example of FIG. 2.

As illustrated in FIG. 2, in the green compact of the Example of the present Invention, the logarithmic approximation formula such as in the Comparative Examples was not established in connection with the relationship between the compression pressure Pₑₓ and the relative density RD. This is because in the transition to densification (compression) of the granules according to the present invention, plastic deformation (flowing) of the thermosetting resin composition occurs simultaneously with brittle fracture of the magnet flakes at a pressure higher than or equal to the yield stress of the thermosetting resin composition, and through such a synergistic effect, the gaps in the periphery of the granules are filled in, while, at the same time, a portion of the granules rotate and are thereby piled on top of one another highly compact in the direction of the pressure axis. Here, the mutual positional relations of the granules (magnetic flakes) are almost stabilized.

Particularly, as shown in FIG. 2 and FIG. 3, in the pressure range extending from the state II to the state III, the plastic deformability (flowability) of the thermosetting resin composition according to the present invention rapidly increases, and thereby, for example, in the final stage of the transition to densification (compression) at a compression pressure of 1 GPa, an increase in the relative density RD accompanied by minimization of the residual voids is observed.

However, in the stage of releasing the compression pressure and releasing the green compact from the molding die cavity, there occurs the phenomenon in which granules (magnet flakes) having a certain angle in the direction of the pressure axis that is basically in the elastic range rotate so as to return to the original positions, and therefore, a green compact that has been released from the mold generally exhibits the so-called phenomenon of elastic recovery (springback).

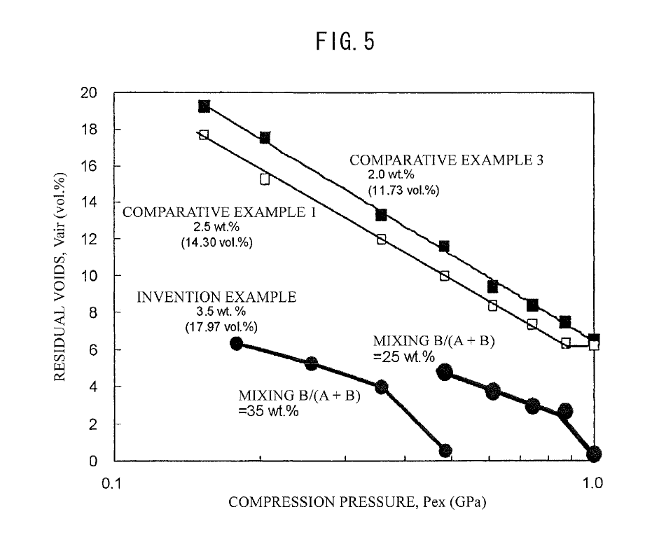

FIG. 4 is a characteristics diagram illustrating the relationship between the compression pressure and the springback in the radial direction of a cylindrical sample. As is obvious from the diagram, the Invention Examples (mixing ratio B/(A+B)=25 wt %, amount of incorporation of the thermosetting resin composition relative to the total mass of the composite magnetic material: 2.5 wt %, 3.0 wt %, 3.5 wt %, and 4.0 wt %) produced a result that the level of springback was clearly lower over the entire pressure range (0.15 GPa to 1.0 GPa) as compared with the Comparative Examples (amount of incorporation of the epoxy resin composition: 2.0 wt % to 2.5 wt %). The reason for this can be explained such that in the green compact according to the present invention that has been compressed to a particular shape at normal temperature and released from the mold, since 1) a granular composite magnetic material in which magnetic flakes are embedded in a resin composition without voids, is used; and 2) the resin composition undergoes plastic deformation (flowing) at a pressure higher than or equal to the yield stress during the transition to densification (compression), the contact surfaces of the granular particles are bonded, and thereby, reduction of the residual voids or the like come to suppress rotation of the granules (magnetic flakes) caused by pressure release and release from the mold, which leads to the diminution of the phenomenon of elastic recovery (springback).

FIG. 5 is a characteristics diagram illustrating the relationship between compression pressure and residual voids. Here, the volume fraction of residual voids, Vₐᵢᵣ, was calculated from the formula: Vₐᵢᵣ=100−V_{mag}−V_{binder}, provided that V_{mag} is equivalent to Mr_{mag}/Mr_{flake}, wherein V_{mag}, V_{binder}, Mr_{mag} and Mr_{flake} represent the volume fraction of magnet flakes having the density adjusted to 7.59 Mg/m³, the volume fraction of the thermosetting resin composition having the density adjusted to 1.25 Mg/m³ (in Comparative Examples, 1.16 Mg/m³), the residual magnetization of the green compact, and the residual magnetization of the magnet flakes (0.9 T), respectively. Meanwhile, the residual magnetization of the green compact was determined by a DC B-H loop tracer (measured magnetic field: Hm±2.4 MA/m). Furthermore, in the diagram, the Invention Example is a material obtained by incorporating a thermosetting resin composition in which the mixing ratio of the unsaturated polyester alkyd (A) and the allylic copolymerizable monomer (B): B/(A+B) is 25 wt % to 35 wt %, in an amount of 3.5 wt % (volume fraction 17.97 vol %) relative to the total mass of the composite magnetic material. Furthermore, Comparative Example 1 is a material obtained by incorporating the epoxy resin composition in an amount of 2.5 wt % (volume fraction: 14.30 vol %) relative to the total mass of the composite magnetic material, and Comparative Example 3 is a material obtained by incorporating the epoxy resin composition in an amount of 2.0 wt % (volume fraction: 11.73 vol %) relative to the total mass of the composite magnetic material. Furthermore, Comparative Example 1 corresponds to Comparative Example 1 shown in FIG. 2.

In regard to the compression pressure Pₑₓ (provided that the pressure range is from 0.15 GPa to 0.87 GPa) and the volume fraction of the residual voids Vₐᵢᵣ of the green compact according to Comparative Example 1, the logarithmic approximation formula: Vₐᵢᵣ=−6.4405Ln(Pₑₓ)+5.3515 was established with a correlation coefficient of 0.9983. However, in Comparative Example 1, the volume fractions of residual voids, Vₐᵢᵣ, at compression pressures of 0.87 GPa and 1.0 GPa were 6.27 vol % and 6.14 vol %, respectively, and it came to be such that even if the compression pressure Pₑₓ was increased to 0.87 GPa or higher, the residual voids Vₐᵢᵣ did not decrease.

Furthermore, in the green compact of Comparative Example 3, the compression pressure Pₑₓ and the volume fraction of residual voids Vₐᵢᵣ at a pressure in the range of 0.15 GPa and 1.0 GPa were such that the logarithmic approximation formula: Vₐᵢᵣ=−6.898Ln(Pₑₓ)+6.4027 was established with a correlation coefficient of 0.9984. In this Example, the residual voids Vₐᵢᵣ at a compression pressure Pₑₓ of 1.0 GPa was 6.5 vol % as a measured value, and the result obtained by calculation from the logarithmic approximation formula was 6.4 vol %. These results imply that in the gap filling achieved only by the brittle fracture of granules (magnet flakes) to the transition to densification (compression), the existence of residual voids cannot be avoided.

On the other hand, in the green compact of the Invention Example (mixing ratio B/(A+B)=25 wt %) shown in FIG. 2, the volume fractions of residual voids V. at compression pressures Pₑₓ of 0.87 GPa and 1.0 GPa were 2.63 vol % and 0.35 vol %, respectively, as shown in FIG. 5. Thus, in contrast to the results of gap filling by brittle fracture during the transition to densification (compression) of the granules (magnet flakes), which occurs in the conventional systems of an epoxy resin and magnet flakes, it came to be such that in the final stage of the transition to densification at, for example, a compression pressure of 1 GPa, most of the residual voids of the green compact could be eliminated. Furthermore, as shown in FIG. 5, when the proportion of the allylic copolymerizable monomer was increased to adjust the ratio B/(A+B) to 35 wt %, the yield stress of the thermosetting resin composition decreased, and most of the residual voids in the green compact could be eliminated at a lower pressure (0.49 GPa).

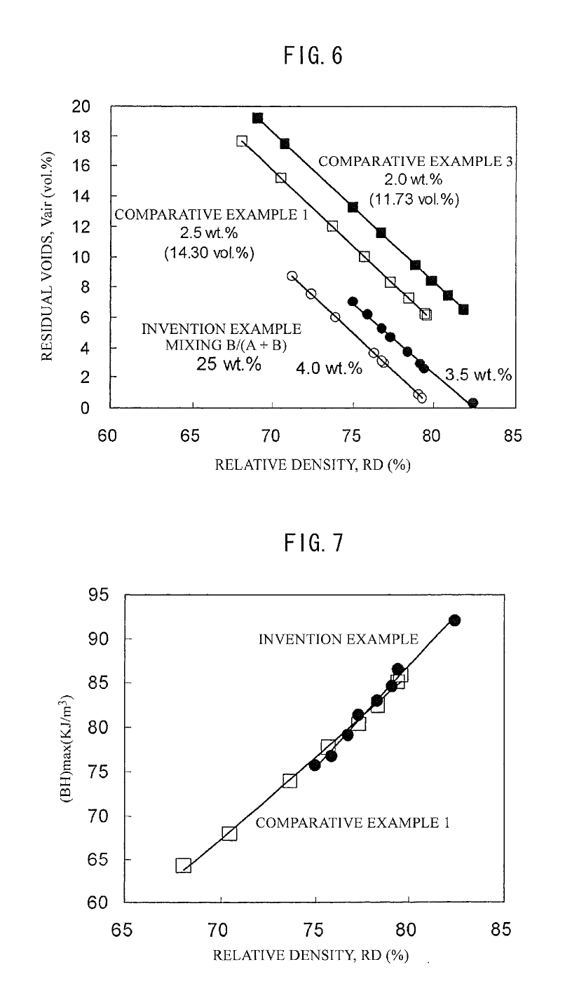

FIG. 6 is a characteristics diagram illustrating the relationship between the relative density RD and the volume fraction of residual voids Vₐᵢᵣ. Meanwhile, the Invention Example shown in the diagram is a characteristics diagram illustrating the relationship between the relative density RD of a green compact obtained by filling 3.3 g of a granular composite magnetic material in which a thermosetting resin composition of an unsaturated polyester alkyd (A) and an allylic copolymerizable monomer (B) at a mixing ratio B/(A+B) of 25 wt %, has been incorporated in an amount of 3.5 wt % or 4.0 wt % relative to the total mass of the composite magnetic material, into a molding die cavity (inner diameter: 10.0 mm), and compressing the composite magnetic material at a pressure of 0.15 GPa to 1.0 GPa, and the volume fraction of residual voids Vₐᵢᵣ. Furthermore, Comparative Examples 1 and 3 are the same samples as those of FIG. 5.

As shown in FIG. 6, also for the green compacts of the Invention Examples and Comparative Examples, linear approximation was established between the relative density RD and the volume fraction of residual voids Vₐᵢᵣₗ. Furthermore, when attention was paid to the samples containing 3.5 wt % (volume fraction: 17.97 vol %) or 4.0 wt % (volume fraction: 20.11 vol %) of the thermosetting resin composition according to the present invention, in the sample with 3.5 wt % of the resin composition, the relative density reached 82.3 8%, but in the sample with 4.0 wt % of the resin composition, the relative density was only up to 78.62%. The volume fraction of residual voids Vₐᵢᵣ was less than 1 vol % in both the samples, and the result in which the relative density RD was higher in the sample with 3.5 wt % of the resin composition than in the sample with 4.0 wt % of the resin composition, implied that in the sample with 4.0 wt % of the resin composition, the spaces that should be originally filled with magnet flakes are replaced by the resin composition.

In consideration from the viewpoint that it is preferable for a bonded magnet to increase the filling ratio of magnet flakes as high as possible and to minimize the volume fraction of residual voids Vₐᵢᵣ in view of performance, in the Invention Examples, it was found that it is preferable to incorporate a thermosetting resin composition having a mixing ratio B/(A+B) of the unsaturated polyester alkyd (A) and the allylic copolymerizable monomer (B) of 25 wt %, in an amount of 3.5 wt % (volume fraction: 17.97 vol% ) relative to the total mass of the composite magnet material to obtain a granular composite magnetic material, and to compress the magnetic material into a particular shape at a pressure of 1 GPa to obtain a green compact.

However, in the green compact according to the present invention such as described above, that is, when a thermosetting resin composition in which the mixing ratio B/(A+B) of an unsaturated polyester alkyd (A) and an allylic copolymerizable monomer (B) is 25 wt % is incorporated in an amount of 3.5 wt % (volume fraction: 17.97 vol %) relative to the total mass of the composite magnetic material to obtain a granular composite magnetic material, and this is processed into an annular green compact having an outer diameter of 8.0 mm, an inner diameter of 5.5 mm, and a length of 5.0 mm at a compression pressure of 1 GPa, the radial crushing strength was 21 MPa. This value was at a level of more than twice the radial crushing strength of an annular green compact obtained under the same conditions and produced into the same shape, by using the granular composite magnetic materials shown in Comparative Example 1 and Comparative Example 3, in which the epoxy resin composition was incorporated in an amount of 2.0 wt % and 2.5 wt %, respectively.

As such, the results of an enhancement of the radial crushing strength of the annular green compact, or a decrease in the springback phenomenon, are effects based on the structure in which there are almost no voids characteristic to the green compacts of the present invention. This suggests a method for producing the rare earth-iron-based bonded magnet having high dimensional accuracy of the present invention.

### [Third Step (Thermal Curing)]

The green compact obtained in the second step by compression molding the granular composite magnetic material according to the present invention, was produced into a compression-molded rare earth-iron-based bonded magnet having very few voids, by thermally curing the curable resin composition that constituted the green compact according to a standard method. The thermosetting resin compositions of the present Example were heated and cured at 150° C. to 200° C. for a time of several minutes to several ten minutes.

FIG. 7 is a characteristics diagram illustrating the relationship between the relative density RD and the maximum energy product (BH)ₘₐₓ of the rare earth-iron-based bonded magnets (diameter 10 mm) corresponding to the Invention Example and Comparative Example 1 shown in FIG. 2. Meanwhile, the compression pressure used at the time of the production of green compacts was 0.15 GPa, 0.21 GPa, 0.36 GPa, 0.49 GPa, 0.62 GPa, 0.74 GPa, 0.87 GPa, and 1.0 GPa, and the (BH)ₘₐₓ values of the various magnets are measured values obtained with a DC B-H loop tracer (measured magnetic field Hm, 2.4 MA/m).

As shown in FIG. 7, it was confirmed that the Invention Example produced a fully dense rare earth-iron-based bonded magnet having a higher (BH)ₘₐₓ value even in the same pressure range (from 0.15 GPa to 1.0 GPa) as that for Comparative Example 1.

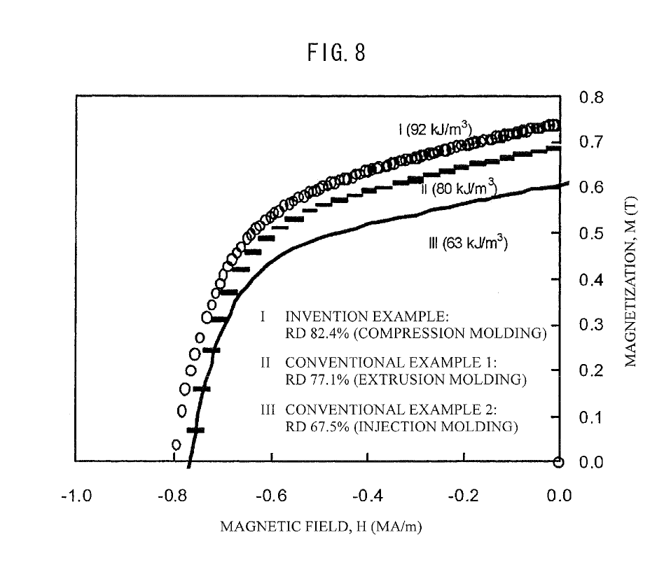

FIG. 8 shows a demagnetization curve (I) of a compression-molded fully dense rare earth-iron-based bonded magnet according to the present invention (a bonded magnet obtained by incorporating a thermosetting resin composition in which the mixing ratio B/(A+B) of the unsaturated polyester alkyd (A) and the allylic copolymerizable monomer (B) is 25 Wt %, in an amount of 3.5 wt % (volume fraction: 17.97 vol %) relative to the total mass of the composite magnetic material to obtain a granular composite magnetic material, processing this into a green compact having a diameter of 10 mm at a compression pressure of 1 GPa, and further thermally curing the green compact).

Meanwhile, the demagnetization curves of (II) and (III) are demagnetization curves of rare earth-iron-based bonded magnets produced under the same conditions except that during the production of the bonded magnets, extrusion molding (Conventional Example 1) or injection molding (Conventional Example 2) was carried out instead of compression molding. For all of these bonded magnets, the residual voids Vₐᵢᵣ were less than 1 vol %.

The bonded magnet of the Invention Example was superior in both the residual magnetization and the (BH)ₘₐₓ value, to those bonded magnets having very few voids that were produced by different processing methods, and even as a rare earth-iron-based bonded magnet obtained by compression molding magnet flakes, the bonded magnet maintained magnetic characteristics of the highest level.

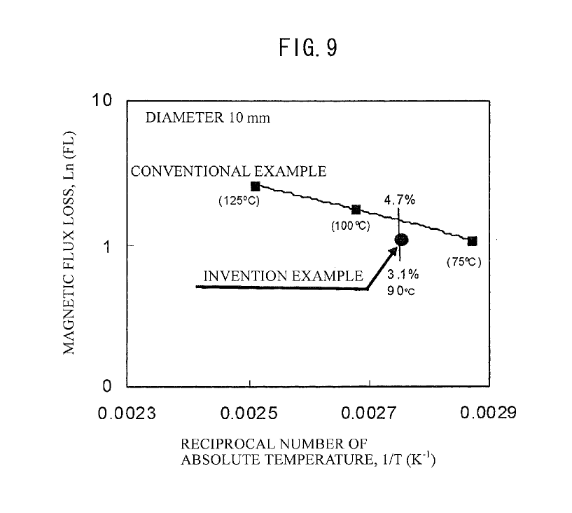

FIG. 9 shows a diagram plotting the magnetic flux loss values (FL) at normal temperature obtained after leaving a rare earth-iron-based bonded magnet to stand at different temperatures for 1000 hours without any surface coating treatment provided thereon [see Takahiko IRIYAMA, Toyonori ARIIZUMI, Takashi ISHIKAWA, Ken OHASHI, Munekatsu SHIMADA, Hiroshi TERADA, Masaaki TOKUNAGA, Hideki NAKAMTJRA, Ryoji NAKAYAMA, Akio HASEBE, Satoshi HIROSAWA, Hirotoshi FUKUNAGA, Katsuyoshi HOTTA, Kenichi MACHIDA, Minoru YAMAZAKI, Fumitoshi YAMASHITA, and Hiroshi YAMAMOTO, “Change over time in incomplete magnetization state of Nd—Fe—B-based bonded magnet”, National Convention Symposium for the Institute of Electrical Engineering of Japan, (2005) S5-7], against the reciprocal number of the standing temperature (absolute temperature) as natural logarithmic numbers. Furthermore, regarding the rare earth-iron-based bonded magnet, a bonded magnet obtained by compressing molding magnetic flakes that have been produced by rapidly solidifying a Nd₁₂Fe₇₇Co₅B₆ (at %) molten alloy having an alloy composition close to the stoichiometric composition of Nd₂Fe₁₄B, together with an epoxy resin (regeneration product of a diglycidyl ether bisphenol A type epoxy oligomer and an isocyanate), into a shape having a diameter of 10 mm and a permeance coefficient Pc of 2, was used. Furthermore, as shown in FIG. 9, in regard to the logarithmic magnetic flux loss Ln(FL) and the reciprocal number of the standing temperature (absolute temperature) 1/T, the relationship: Ln(FL)=−4093.8(1/T)+12.802 was established with a correlation coefficient of 0.9883.

Thus, when the activation energy ΔE involved in the magnetic flux loss was determined while the gas constant R was assumed to be 1,9872 cal·mol⁻¹·K⁻¹, the activation energy ΔE was found to be 8.13 cal·mol⁻¹, and this value was approximately ½ or less of the activation energy for thermal degradation of a general polymer material. In the rare earth-iron-based bonded magnet, it is considered that moisture or oxygen that has been incorporated into the residual voids present in the inner part of the magnet accelerates a structural change such as oxidation or corrosion of the magnet flakes in the inner part of the magnet [see Shuji MINO, Masahiro ASANO, and Naoyuki ISHIGAKI, “Development of anisotropic Nd—Fe—B-based bonded magnet”, Sumitomo Tokushu Kinzoku Kibo, 12 (1997) pp. 43-48].

On the other hand, the bonded magnet of the present invention, that is, a compression-molded fully dense rare earth-iron-based bonded magnet which had a residual void ratio of less than 1 vol % and was not surface coating treated, obtained by incorporating a thermosetting resin composition in which the mixing ratio B/(A+B) of an unsaturated polyester alkyd (A) and an allylic copolymerizable monomer (B) was 25 wt %, at a proportion of 3.5 wt % (volume fraction: 17.97 vol %) relative to the total mass of the composite magnetic material to obtain a granular composite magnetic material, processing this into a green compact having a diameter of 10 mm at a compression pressure of 1 GPa, and thermally curing the green compact, was such that the magnetic flux loss was 3.1% when the bonded magnet was left to stand for 1000 hours at 90° C. Thus, a tendency that the magnetic flux loss was suppressed by at least about ⅓ as compared with the magnetic flux loss of 4.7% of the conventional examples described above obtainable under the same conditions of temperature and standing time, was observed.

The present invention was achieved by paying attention to a green compact in which the residual voids have been significantly reduced without decreasing the volume fraction of rare earth-iron-based magnet flakes, a rare earth-iron-based bonded magnet obtainable from the green compact, and particularly the brittle fracture of magnet flakes and the plastic flow of the thermosetting resin composition in the transition to densification (compression). 1) Since residual voids are almost non-existent, springback of the green compact that is released from a molding die cavity is suppressed, and also, since the radial crushing strength is increased, even if the existing facilities such as a compression molding machine are directly used in the production of magnets in an industrial scale, the dimensional accuracy of the magnets can be increased. Furthermore, 2) since the bonded magnet has a structure in which residual voids are almost absent, without having the magnetic characteristics deteriorated, structural changes such as oxidation or corrosion of magnetic flakes in the inner part of the magnet caused by heat and the moisture or oxygen incorporated into residual voids, can be suppressed. Thus, the invention has an inventive step of markedly increasing reliability against demagnetization due to heat, dimensional change, and deterioration in the mechanical strength, and therefore, the industrial applicability of the invention is very high.

Therefore, the fully dense rare earth-iron-based bonded magnet produced by the production method of the present invention is expected to be applicable in various small-sized motors where high dimensional stability and mechanical strength are required, permanent demagnetization is suppressed, and high weather resistance is required, such as motors for vehicles, brushless motors for office appliance equipment, and spindle motors for hard disks.

What is claimed is:

1. A method for producing a fully dense rare earth-iron-based bonded magnet, the method comprising:
a first step of kneading a thermosetting resin composition that is non-tacky at normal temperature and has fluidity with a yield stress, with rare earth-iron-based magnet flakes in a molten state of the resin composition, and thereby producing a granular composite magnetic material that is solid at normal temperature;
a second step of filling the granular composite magnetic material into a cavity, applying a uniaxial pressure higher than or equal to the yield stress of the thermosetting resin composition to the granular composite magnetic material at a temperature lower than or equal to the melting point of the granular composite magnetic material, and thereby producing a green compact in which voids are reduced as a result of an interaction between brittle fracture of the magnet flakes and plastic deformation (flowing) of the thermosetting resin composition, the rare earth-iron-based magnet flakes are piled on top of one another highly compact in the direction of the pressure axis, and the mutual positional relations of the magnet flakes are defined to be almost regularly; and
a third step of heating the green compact, and curing the thermosetting resin composition that constitutes the green compact.

2. The method for producing a fully dense rare earth-iron-based bonded magnet according to claim 1, wherein the green compact having a particular shape is definable as a green compact in which the volume fraction of the rare earth-iron-based magnet flakes in the green compact is 78.87 vol % or more, the volume fraction of the thermosetting resin composition is 18.05 vol % or less, and the volume fraction of residual voids is 3.08 vol % or less in a condition that the sum of the volume fractions of the rare earth-iron-based magnet flakes, the thermosetting resin composition and the residual voids is 100 vol %.

3. The method for producing a fully dense rare earth-iron-based bonded magnet according to claim 1, wherein the thermosetting resin composition contains an unsaturated polyester alkyd (A) that is solid at normal temperature, an allylic copolymerizable monomer (B), and an organic peroxide.

4. The method for producing a fully dense rare earth-iron-based bonded magnet according to claim 3, wherein the unsaturated polyester alkyd (A) comprises dicarboxylic acid components comprising phthalic acid and fumaric acid at a molar ratio of phthalic acid/fumaric acid=5/5 to 1/9, and glycol components comprising 1,4-butanediol and another glycol at a molar ratio of 1,4-butanediol/other glycol=7/3 to 10/0, and has a melting point of 80° C. to 120° C. and an acid value of 20 or less.

5. The method for producing a fully dense rare earth-iron-based bonded magnet according to claim 3, wherein the allylic copolymerizable monomer (B) is triallyl isocyanurate.

6. The method for producing a fully dense rare earth-iron-based bonded magnet according to claim 3, wherein the mixing ratio of the unsaturated polyester alkyd (A) and the allylic copolymerizable monomer (B) is B/(A+B)=5 wt % to 40 wt % as a mass ratio.

7. The method for producing a fully dense rare earth-iron-based bonded magnet according to claim 1, wherein the rare earth-iron-based magnet flakes are magnetically isotropic rare earth-iron-based rapidly solidified flakes comprising at least one or more kinds selected from the group consisting of an R—Fe—B-based magnet, an R—Fe(Co)—B-based magnet having a portion of Fe replaced with Co, an R—Fe—B-M-based magnet, an R—Fe—(Co)—B-M-based magnet having a portion of Fe replaced with Co, an R₂Fe₁₄B nanocrystalline structure having an alloy composition comprising unavoidable impurities, an R₂Fe(Co)₁₄B nanocrystalline structure having an alloy composition comprising unavoidable impurities and having a portion of Fe replaced with Co, a nanocomposite structure of α-Fe and R₂Fe₁₄B, a nanocomposite structure of α-Fe and R₂Fe(Co)₁₄B having a portion of Fe replaced with Co, a Sm—Fe—N-based magnet, a Sm—Fe-M′-N-based magnet, a Sm₂Fe₁₇Nₓ (x≈3) nanocrystalline structure having an alloy composition comprising unavoidable impurities, and a nanocomposite structure of α-Fe and Sm₂Fe₁₇Nₓ (x≈3) where R represents any one rare earth elements selected from yttrium (Y), cerium (Ce), praseodymium (Pr), neodymium (Nd), gadolinium (Gd), terbium (Tb), dysprosium (Dy) and holmium (Ho); M represents one kind or a combination of two or more kinds selected from silicon (Si), aluminum (Al), niobium (Nb), zirconium (Zr), hafnium (Hf), molybdenum (Mo), gallium (Ga), phosphorus (P) and carbon (C); and M′ represents one kind or a combination of two or more kinds selected from hafnium (Hf), zirconium (Zr), silicon (Si), niobium (Nb), titanium (Ti), gallium (Ga), aluminum (Al), thallium (Ta), and carbon (C).

8. The method for producing a fully dense rare earth-iron-based bonded magnet according to claim 1, wherein the fully dense rare earth-iron-based bonded magnet thus obtained has a residual magnetization Mr of 0.74 T or greater at an external magnetic field Hm of 2.4 MA/m, and a maximum energy product (BH)ₘₐₓ of 90 kJ/m³ or greater.

9. A fully dense rare earth-iron-based bonded magnet, having a volume fraction of rare earth-iron-based magnet flakes of 78.87 vol % or more, a volume fraction of a thermosetting resin composition of 18.05 vol % or less, and a volume fraction of residual voids of 3.08 vol % or less in a condition that the sum of the volume fractions of the rare earth-iron-based magnet flakes, the thermosetting resin composition and the residual voids is 100 vol %.

10. The fully dense rare earth-iron-based bonded magnet according to claim 9, having a residual magnetization Mr of 0.74 T or greater at an external magnetic field Hm of 2.4 MA/m, and a maximum energy product (BH)ₘₐₓ of 90 kJ/m³ or greater.

11. The fully dense rare earth-iron-based bonded magnet according to claim 9, wherein the thermosetting resin composition comprises an unsaturated polyester alkyd (A) that is solid at normal temperature, an allylic copolymerizable monomer (B), and an organic peroxide.

12. The fully dense rare earth-iron-based bonded magnet according to claim 11, wherein the unsaturated polyester alkyd (A) comprises dicarboxylic acid components comprising phthalic acid and fumaric acid at a molar ratio of phthalic acid/fumaric acid=5/5 to 1/9, and glycol components comprising 1,4-butanediol and another glycol at a molar ratio of 1,4-butanediol/other glycol=7/3 to 10/0, and has a melting point of 80° C. to 120° C. and an acid value of 20 or less.

13. The fully dense rare earth-iron-based bonded magnet according to claim 11, wherein the allylic copolymerizable monomer (B) is triallyl isocyanurate.

14. The fully dense rare earth-iron-based bonded magnet according to claim 11, wherein the mixing ratio of the unsaturated polyester alkyd (A) and the allylic copolymerizable monomer (B) is B/(A+B)=5 wt % to 40 wt % as a mass ratio.

15. The fully dense rare earth-iron-based bonded magnet according to claim 9, wherein the rare earth-iron-based magnet flakes are magnetically isotropic rare earth-iron-based rapidly solidified flakes comprising at least one or more selected from the group consisting of an R—Fe—B-based magnet, an R—Fe(Co)—B-based magnet having a portion of Fe replaced with Co, an R—Fe—B-M-based magnet, an R—Fe—(Co)—B-M-based magnet having a portion of Fe replaced with Co, an R₂Fe₁₄B nanocrystalline structure having an alloy composition comprising unavoidable impurities, an R₂Fe(Co)₁₄B nanocrystalline structure having an alloy composition comprising unavoidable impurities and having a portion of Fe replaced with Co, a nanocomposite structure of α-Fe and R₂Fe₁₄B, a nanocomposite structure of α-Fe and R₂Fe(Co)₁₄B having a portion of Fe replaced with Co, a Sm—Fe—N-based magnet, a Sm—Fe-M′-N-based magnet, a Sm₂Fe₁₇Nₓ (x≈3) nanocrystalline structure having an alloy composition comprising unavoidable impurities, and a nanocomposite structure of α-Fe and Sm₂Fe₁₇Nₓ (x≈3) where R represents any one rare earth elements selected from Y, Ce, Pr, Nd, Gd, Tb, Dy and Ho; M represents one kind or a combination of two or more kinds selected from Si, Al, Nb, Zr, Hf, Mo, Ga, P and C; and M′ represents one kind or a combination of two or more kinds selected from Hf, Zr, Si, Nb, Ti, Ga, Al, Ta and C.
